(19) United States
(12) Patent Application Publication
(10) Pub. No.: US 2010/0176236 A1
(43) Pub. Date: Jul. 15, 2010

(54) HIGH PERFORMANCE TIGHTENER

(75) Inventors: GUNTER CLUTE, Bloomfield Hills, MI (US); Jon E. Burrow, Ortonville, MI (US)

Correspondence Address: AUTOLIV ASP, 3350 AIRORT ROAD, OGDEN, UT, 84405, US

(73) Assignee: AUTOLIV ASP, INC., Ogden, UT (US)

(21) Appl. No.: 12/351,315

(22) Filed: Jan. 9, 2009

(51) Int. Cl. B60R 22/46; B65H 75/48; B60R 22/34; B60R 22/36

(52) U.S. Cl. 242/394; 242/389

(57) ABSTRACT

A self stopping seat belt retractor is provided with a spindle for winding a seat belt thereonto and unwinding a wound seat belt therefrom and a housing rotatably supporting the spindle and having a locking device that includes a locking means for the spindle that can be controlled in a vehicle sensitive and/or belt sensitive manner into engagement with a toothed gearing system on the side of the housing. A tightening device operating on the spindle includes a drive wheel, which is, prior to the release of the tightening device, secured in a force-transmitting manner on the housing, is connectable upon release of the tightening device with the spindle, whereby the drive wheel of the tightening device is connectable via the locking device with the spindle for the transmission of force to the spindle.

### FIELD

The present invention relates generally to seat belt restraint apparatus for restraining an occupant of an automobile, and more particularly relates to a retractor having a pretensioner for controlling load limitation aspects of the restraint system.

### BACKGROUND

Seat belt restraint systems for automobiles often include a pretensioner which is structured to apply tension to the seat belt when an impact event such as an accident situation is detected. When the pretensioner is activated, the pretensioner eliminates any slack in the seat belt, and thus controls the physical space between the occupant and the seat belt. In this manner, the occupant of the seat is coupled with the seat belt as the occupant initially moves forward relative to the seat, thereby controllably restraining the occupant, reducing occupant excursion, and preventing undue loads when the occupant moves forwardly into the seat belt.

A retractor is another standard component of a seat belt restraint system which includes a spool receiving the webbing material of the seat belt. The spool is used to wind up and store the webbing. Generally, the spool is locked in place upon detection at an impact situation in order to restrain the occupant via the seat belt. Recently, retractors have been designed having one or more force limiting elements which are structured to allow the spool to rotate and pay out the webbing material of the seat belt upon reaching predetermined force levels between the occupant and seat belt. In this manner, the restraint force imposed on the occupant can be limited in a controlled manner, thereby providing a certain load limitation characteristics.

Despite these and other improvements to automobile restraint systems, there remains a need to provide a retractor that includes a pretensioner while providing increased control and variation over the load limitation characteristics of the retractor system.

### BRIEF SUMMARY

One embodiment of a seat belt retractor generally comprises a spindle, a frame, a torsion bar, a tread head, a locking mechanism, and a pretensioner. The spindle is for winding a seat belt thereonto and unwinding a wound seat belt therefrom, and the frame rotatably supports the spindle. The torsion bar has opposing first and second ends, and the first end is connected to the spindle for fixed rotation therewith. The tread head is connected to the second end of the torsion bar for fixed rotation therewith. The locking mechanism is operably coupled to the tread head to selectively fix rotation of the tread head relative to the frame. The pretensioner has an actuating element and a drive wheel, wherein the drive wheel is directly connected to the tread head for fixed rotation therewith. The pretensioner is operable from an inactive state to an active state. The actuating element is disengaged from the drive wheel in the inactive state to permit rotation of the drive wheel and tread head. The actuating element is engaged with the drive wheel in the active state to transmit force to the drive wheel.

According to more detailed aspects of this embodiment, the drive wheel includes an opening defining an inner engagement surface, and the tread head defines an outer engagement surface rotatably connected to the inner engagement surface of the drive wheel. The inner engagement surface defines a drive wheel spline, and the outer engagement surface defines a tread head spline meshed with the drive wheel spline. The opening has a non-circular shape, and a body of the tread head includes a non-circular shape matching the shape of the opening. Preferably, the drive wheel and tread head are unitarily formed as a single piece or the drive wheel is press-fit on the tread head. When the locking mechanism includes a lock dog pivotally connected to the tread head, the lock dog is responsive to rotation of the tread head to rotate radially outwardly. A pretensioner cover is connected to the frame and defines a toothed gearing system having a teeth shaped to cooperate with the lock dog to permit winding of the seat belt and prevent unwind of the seat belt. Operation of the pretensioner in the active state drives the tread head such that the lock dog rotates radially outwardly, wherein the locking mechanism and its lock dog over-ratchet the toothed gearing system.

Another embodiment of a seat belt retractor generally comprises a spindle, a frame, a torsion bar, a tread head, a locking mechanism, and a pretensioner. The spindle is for winding a seat belt thereonto and unwinding a wound seat belt therefrom, and the frame rotatably supports the spindle. The torsion bar has opposing first and second ends, and the first end is connected to the spindle while the second end is connected to the tread head. The locking mechanism is operably coupled to the tread head to selectively fix rotation of the tread head relative to the frame. The pretensioner has an actuating element, a drive wheel, and a clutch mechanism. The drive wheel is rotatably coupled to the tread head via the clutch mechanism for selective rotation therewith. The clutch mechanism includes a coupling element moveably connected to the drive wheel. An inactive state of the pretensioner is characterized by the actuating element being engaged with the drive wheel, and the clutch mechanism decoupling the drive wheel from the tread head, to permit rotation of the tread head. An active state of the pretensioner is characterized by the clutch mechanism coupling the drive wheel to the tread head to transmit force to the torsion bar and spindle.

Yet another embodiment of a seat belt retractor generally comprises a spindle, a frame, a torsion bar, a tread head, a locking mechanism, a pretensioner and a bending element. The spindle is for winding a seat belt thereonto and unwinding a wound seat belt therefrom, and the frame rotatably supports the spindle. The torsion bar has opposing first and second ends, and the first end is connected to the spindle while the second end is connected to the tread head. The locking mechanism is operably coupled to the tread head to selectively fix rotation of the tread head relative to the frame. The pretensioner has an actuating element and a drive wheel, wherein the drive wheel is connected to the tread head for rotation therewith. The bending element has a first end and a second end. The first end is coupled to the tread head for fixed rotation therewith, and the second end is coupled to the spindle proximate the second end of the torsion bar for engagement therewith.

According to more detailed aspects of this embodiment, the retractor limits loading of the seat belt by deforming the bending element and the torsion bar. The bending element preferably provides an initial high load limitation. The bending element is designed to fail under a predetermined failure load, and the torsion bar is activated upon failure of the torsion bar. In one version, the bending element is a torsion pipe, wherein the second end of the torsion pipe is coupled to the spindle proximate the second end of the torsion bar for fixed rotation therewith. In another version, the bending element is an elongated wire designed to bend in a predetermined manner under load.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a perspective view of another embodiment of a seat belt retractor;

FIG. 2 is a cross-sectional view of the seat belt retractor of FIG. 1;

FIG. 3 is an exploded view of the seat belt retractor in FIG. 1;

FIG. 4 is an enlarged view of a component of the seat belt retractor shown in FIG. 3;

FIG. 5 is a perspective view of a portion of the seat belt retractor of FIG. 1;

FIG. 6 is a different perspective view of a portion of the seat belt retractor of FIG. 1;

FIG. 7 is a cross-sectional view of another embodiment of a seat belt retractor; and

FIG. 8 is a partial cross-sectional view of yet another embodiment of a seat belt retractor.

### DESCRIPTION OF SPECIFIC EMBODIMENTS

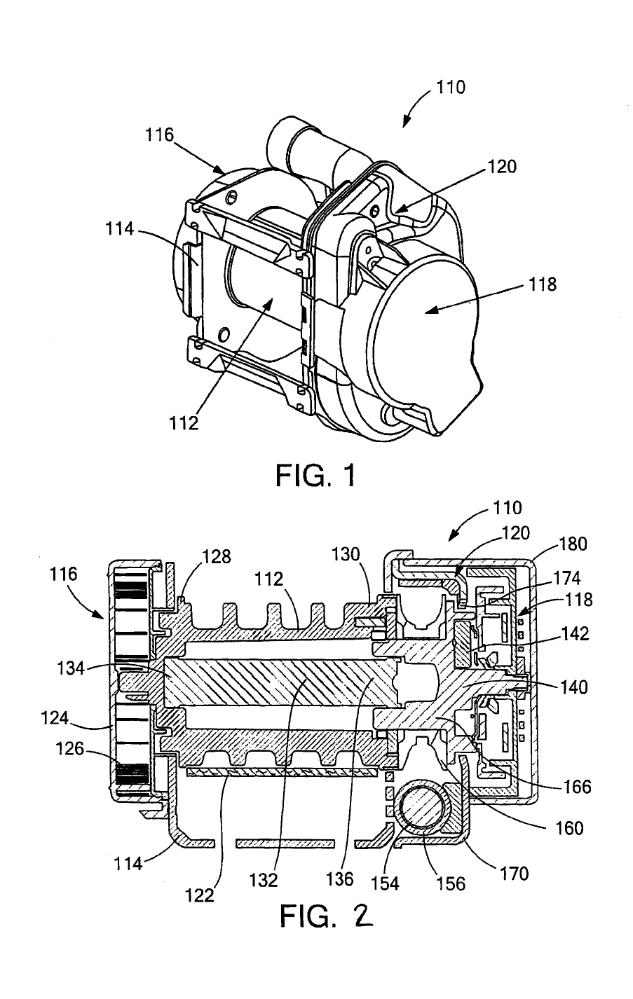

Turning now to FIGS. 1 to 7, one embodiment of a retractor 110 includes a spindle 112 for receiving a portion of the seat belt 122 (FIG. 2). A retractor frame 114 locates and supports the spindle 112 with bearing surfaces so that the spindle 112 may rotate within the retractor frame 114. The spindle 112 rotates about an axis in a first direction for retraction and/or tightening of the seat belt 122 and alternatively, rotates in a second direction (e.g. opposed direction) for protraction of the seat belt 122. A rewind mechanism 116 includes a cap 124 enclosing a rewind spring 126 that is operatively connected to a first end 128 of the spindle 112 to wind up the seat belt 122 during normal operation, as is known in the art. At the side of the frame 114 opposite the rewind mechanism 116, a locking mechanism 118 is operable to generally fix rotation of the spindle 112, while a pretensioner 120 is operable to wind up the seat belt 122 onto the spindle 112, as will be discussed further hereinbelow.

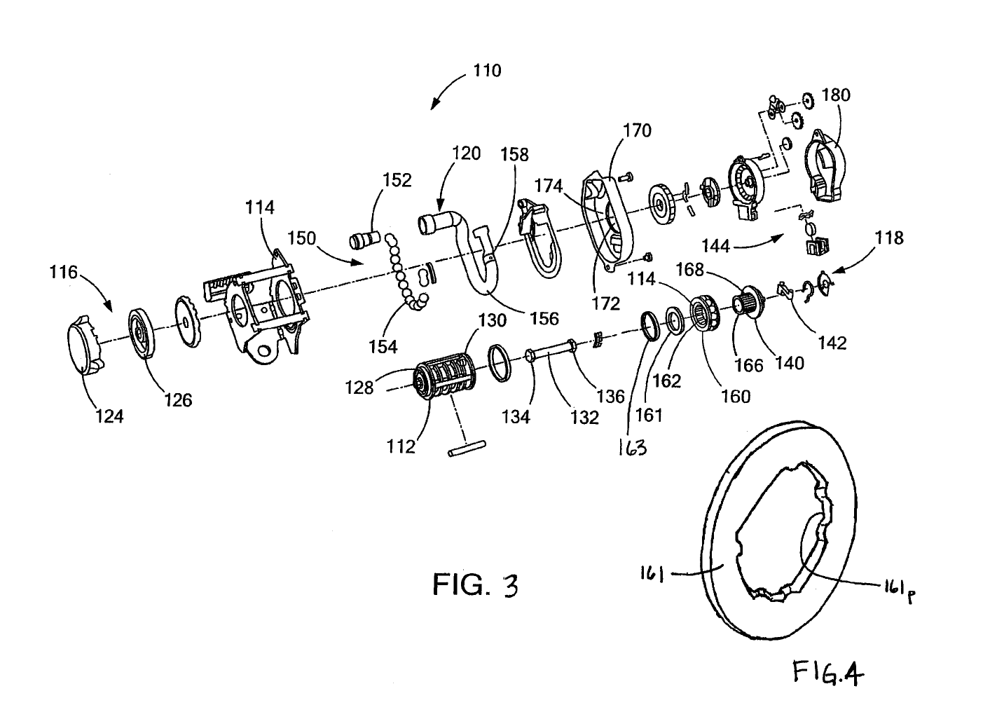

The locking mechanism 118 and pretensioner 120 are operably coupled to the spindle 112 through a torsion bar 132, best seen in FIGS. 2 and 3. The torsion bar 132 includes a first end 134 splined directly to the spindle 112 for fixed rotation therewith. Opposite the first end 134 is a second end 136 of the torsion bar 132, and the locking mechanism 118 and pretensioner 120 control rotation of the spindle 112 via engagement with this second end 136. The torsion bar 132 is structured to operate as a load limiting element, whereby twisting of the torsion bar 132 may permit some unwinding or payout of the seatbelt 122 to limit the belt load on the vehicle occupant. While a torsion bar 132 has been depicted, numerous other load limiting elements may be employed, including tubes, sleeves, bending wires and the like, as will be appreciated by those skilled in the art.

As best seen in FIGS. 2 and 3, the second end 136 of the torsion bar 132 is splined to a tread head 140 for fixed rotation therewith. As indicated above, the locking mechanism 118 and pretensioner 120 operate through the torsion bar 132, and in particular through the tread head 140 connected to the second end 136 of the torsion bar 132. Notably in this example, the retractor locking mechanism 118 and the pretensioner 120 are disposed adjacent to each other and are arranged on the same side of the retractor frame 114. This configuration provides a more compact seatbelt pretensioner assembly and other benefits as previously discussed.

The locking mechanism 118 includes a lock dog 142 pivotally mounted to the tread head 140 for rotation relative thereto. The lock dog 142 is belt-sensitive, and rotates radially outwardly when the tread head 140 spins at a sufficient rate. The lock dog 142 selectively locks the tread head 140 and second end 136 of torsion member 132 during an impact event such as a vehicle collision, or upon sufficient deceleration of the vehicle, thereby providing an “emergency locking retractor” function as is well known in the art. The locking mechanism 118 may also include a vehicle-sensitive actuator 144 in addition to or in place of the belt-sensitive mechanism described. Generally, in response to a change in vehicle attitude/acceleration, the actuator 144 operates to rotate the lock dog 142 to rotationally fix the tread head 140. A signal from the electric control unit may also be employed. Further details of such locking mechanisms may be found above and in U.S. Pat. Nos. 6,105,894, 6,592,064 and 6,616,081, the disclosures of which are hereby incorporated by reference in their entirety.

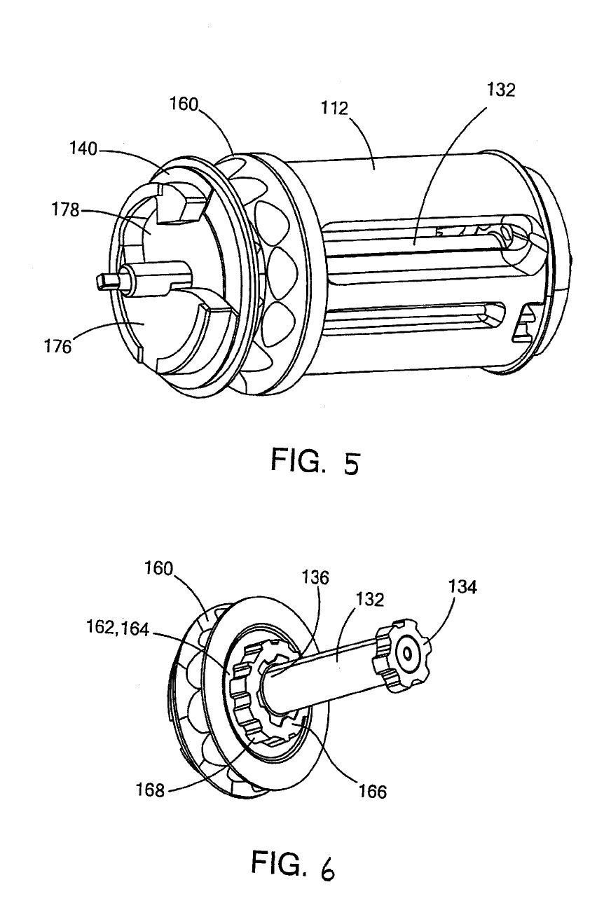

In the depicted embodiment, the locking mechanism 118 interacts with the cover 170 of the pretensioner 120, which has an opening 172 formed therethrough. A portion of the tread head 140 is disposed through the opening 172. The lock dog 142 is pivotally mounted within the recess 178 defined by the profiled end surface 176 of the tread head 140 (FIG. 5, discussed further hereinbelow), and disposed proximate the opening 172. As best seen in FIG. 3, the opening 172 has a perimeter with the retractor lock teeth 174 formed thereon. The lock dog 142 pivots to engage the retractor lock teeth 174 to selectively lock the tread head 140 to prevent protraction of the seatbelt 122.

Through blocking of the tread head 140, the spindle 112 is prevented from rotating to protract the seatbelt 122, thereby restraining the occupant. However, the retractor 110 and the torsion bar 132 also provide a load limitation function in order to limit the restraint force imposed on the occupant. Upon reaching a predetermined restraint force, the spindle 112 will begin to rotate and “pay out” the seat belt 122 by actuation of the torsion bar 132. That is, upon reaching a predetermined force, the torsion bar 132 will twist to allow some rotation of the spindle 112 relative to the tread head 140 (and hence relative to second end 136 of torsion bar 132) which is fixed by the retractor locking mechanism 118.

As previously indicated, the pretensioner 120 operates to wind up the seat belt 122 onto the spindle 112 to further restrain the occupant and take up any slack in the seat belt 122. The pretensioner 120 is activated by an electronic control unit (not shown) via a pretension signal. As best seen in FIGS. 2-6, the pretensioner 120 includes a drive mechanism 150 that is actuated to effectuate rotation of the spindle 112 via the torsion bar 132. In particular, the drive mechanism 150 preferably includes a gas generator 152 (e.g. a pyrotechnic charge), pretensioner balls 154 and a tube 156. The tube 156 has may be in the form of a roto tube which includes at least one looped configuration and an open end 158 opposite the gas generator 152. The pretensioner balls 154 serve as an actuating element are contained in the tube 156 and driven by the gas generator 152 past a drive wheel 160 positioned proximate the open end 158. The pretensioner is operable between an inactive state, where the pretensioner balls 154 are not engaged with the drive wheel 160, and an active state where the balls 154 engage the drive wheel 160 for transmitting force thereto.

The drive wheel 160 (or other driven member of the pretensioner, depending on its design) is connected to the tread head 140 for fixed rotation therewith. In the depicted embodiment, and as best seen in FIGS. 3 and 6, the drive wheel 160 includes an opening 162 defining an interior engagement surface having a plurality of teeth 164. The tread head 140 correspondingly includes a main body 166 defining an exterior engagement surface having a plurality of teeth 168 structured to mate with the teeth 164 of the drive wheel 160. As such the drive wheel 160 is rotatably fixed to the tread head 140 for transmitting energy from the pretensioner 120 to the spindle 112 via the torsion bar 132. Preferably, the drive wheel 160 is located between the spindle 112 and the locking mechanism 118 (and the profiled end surface 176 of the tread head 140) as shown. Movement of the pretensioner balls 154 rotates the drive wheel 160, and due to the fixed rotational couplings, also rotates the spindle 112 via the tread head 140 and torsion bar 132. Maintenance of pressure on the pretensioner balls 154 in the active state (e.g., once the ball collection area is full) serves to block rotation of the drive wheel 160 in the unwind direction, and thus fixes the tread head 140 and second end 136 of the torsion bar 132, complimentary to and supplemental to the locking mechanism 118.

While this fixed rotational coupling via the teeth 164 and teeth 168 have been described, it will be recognized that the drive wheel 160 could also be coupled to the tread head 140 via a press-fit, a spline or other non-circular configuration of the main body 166 (of the tread head 140) and opening 162 in the drive wheel 160), or via a unitary construction of the tread head 140 and drive wheel 160 as a single piece. In these designs, there is no clutch (e.g. an on-clutch or off-clutch) or other operable mechanism that couples the pretensioner 120 to the torsion bar 132 and/or spindle 112. As such, the retractor design is much simpler and easier to manufacture, while still providing a locking function, a pretensioning function, and a load limitation function.

A suitable bearing 161, best seen in FIGS. 3 and 4, may be provided between the tread head/drive wheel 140/160 and the spindle 112 to control the friction therebetween. The bearing 161 includes a profiled aperture 161p that is structured to rotationally engage the main body 166 of the tread head 140. If desired, an anti-friction ring 163 (FIG. 3) may also be positioned around the exterior of the bearing 161 (or the annular surface of the bearing 161 may be coated), to further assist in reducing the friction.

As previously mentioned, the pretensioner 120 further includes a cover 170 for containing and locating many of the components of the pretensioner 170. The cover 170 defines an opening 172 defining an interior engagement surface having a plurality of teeth 174 for selectively engaging the lock dog 142 of the locking mechanism 118. The plurality of teeth 174 define a toothed gearing system that when engaged prevents unwinding of the spindle 112, but permits winding of the spindle 112 via over-ratcheting of the lock dog 142 along the teeth 174. As best seen in FIG. 6, the tread head 140 includes a profiled end surface 176 defining a recess 178 shaped to receive the lock dog 142 and permit rotation thereof for locking the tread head 140 to the cover 170. Although use of the pretensioner cover 170 to define the engagement surface for the locking mechanism 118 is preferred, a locking mechanism cover 180 (FIG. 3) or the frame 114 could be structured for engagement of the lock dog 142. Further details of the pretensioner 120 and its cover 180 may be found in copending application Ser. No. 12/195,591 filed Aug. 21, 2008, the disclosure of which is incorporated herein by reference in its entirety. Likewise, other pretensioner designs may be employed with the present invention, several exemplary pretensioners being disclosed in U.S. patent application Ser. No. 11/115,583, filed Apr. 27, 2005, the disclosure of which is hereby incorporated by reference in its entirety.

Accordingly, it will be recognized by those skilled in the art that upon detection of an imminent impact event, or rapid deceleration of the vehicle, etc., the pretensioner 120 may be fired to rotate the drive wheel 160. Through its fixed rotational coupling, operation of the pretensioner in its active state causes rotation of the tread head 140, and hence the belt-sensitive lock dog 142 moves radially outwardly. Over-ratcheting of the lock dog along teeth 174 in the pretensioner cover 170 permits the spindle 112 to be rotated (via the torsion bar 132) to wind up the seat belt 122. Maintenance of the pressure on the pretensioner balls 154 effectively locks the drive wheel 160, and hence the tread head 140 and second end 136 of the torsion bar 132. At the same time, operation of the locking mechanism 118, either as a belt-sensitive or vehicle-sensitive controlled locking device, also serves to rotationally fix the tread head 140 and second end 136 of the torsion bar 132. When the pretensioner 120 has not fired or otherwise is in its inactive state, the pretensioner balls 154 do not engage the drive wheel 160, and hence the drive wheel 160 and tread head 140 are free to rotate. Thus, when the pretensioner 120 is in its inactive state, the locking mechanism 118 may still operate to rotationally fix the tread head 140. In this manner, the locking mechanism 118 and pretensioner 120 may be independently activated and operated, while also cooperating via the fixed rotational coupling of the tread head 140 and drive wheel 160 to supplement and/or back-up each other in locking the spindle 112 and activating the load limitation provided by torsion bar 132.

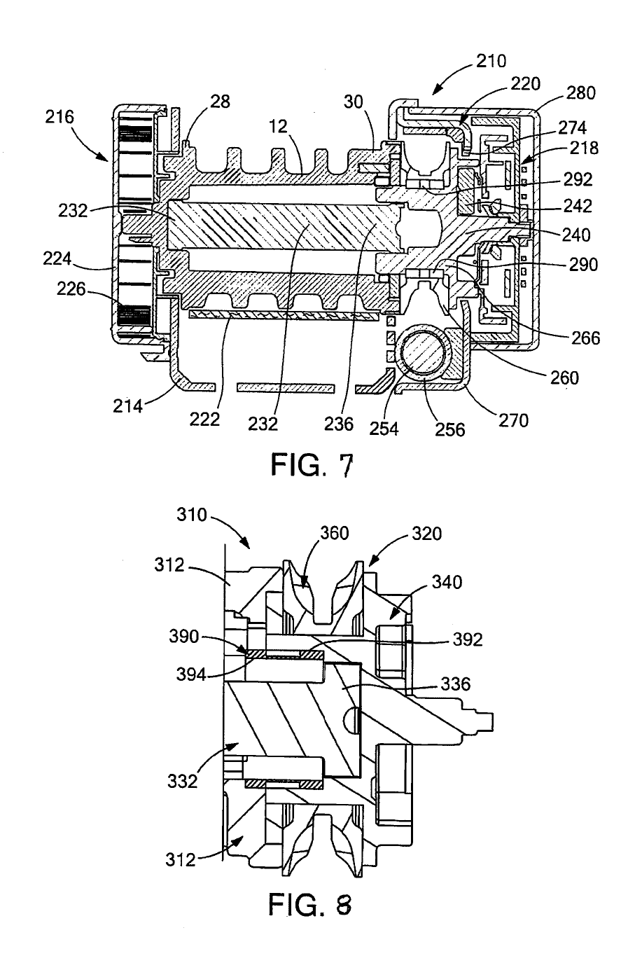

Another embodiment of a retractor 210 having a pretensioner 220 is depicted in FIG. 7. This embodiment is substantially similar to the prior embodiment of FIGS. 1-6, but adds a clutch mechanism 290 between the pretensioner 220 and the spindle 212. As shown in FIG. 7, the pretensioner is coupled to the spindle 212 via the torsion bar 232 and tread head 240, and the clutch mechanism 290 selectively couples tread head 240 to the drive wheel 260 of the pretensioner 220. Additionally, the leading pretensioner balls 154 are provided in contact with the drive wheel 260 of the pretensioner 220. In normal operation, the clutch mechanism disengages the drive wheel 260 from the tread head 240 and spindle 212, such the seat belt 222 is free to wind and unwind from the spool 212 in normal operation of the retractor 210 and its other elements. During an emergency event or other event where the seat belt is desired to be tightened and wound upon the spool 212, the clutch mechanism 290 is activated to rotationally couple the drive wheel 260 to the tread head 240, preferably at about the same time or shortly prior to the activation of the pretensioner 220.

The clutch mechanism 290 may take many forms and include various coupling elements 292, such as rotatable coupling pawls, toothed gearing systems, rings, slidable or rotatable structures, and the like. The coupling elements may be driven mechanically or electronically, and preferably are linked to the activation of the pretensioner 220. For example, the pyrotechnic charge (e.g. 152) may also be used to drive the coupling element 292 of the clutch mechanism 290, or the coupling element 292 may be rotationally sensitive such that rotation of the drive wheel 260 of the pretensioner 220 activates the clutch, or an electronic signal (e.g. the signal that activates the pretensioner 220 or a separate signal) may be used to activate the coupling element 292 and the clutch mechanism 290. Further details of embodiments of suitable clutches are found in U.S. patent application Ser. No. 11/222,130 filed Sep. 8, 2005, the contents of which are incorporated herein by reference in their entirety.

Another embodiment of a retractor 310 having a pretensioner 320 is depicted in FIG. 8. This embodiment is substantially similar to the prior embodiments of FIGS. 1-7, but includes a relatively short torsion pipe 390. The torsion pipe 390 is rotationally coupled to the tread head 340 at a first end 392 for fixed rotation therewith, and rotationally coupled to the spindle 312 at a second end 394 for fixed rotation therewith. Upon blocking of the tread head 340 (and hence the second end 336 of the torsions bar 332), either via the pretensioner or the locking mechanism, belt load is absorbed directly by the torsion pipe 390, which is structured to provide an immediate absorption of energy to quickly step down the high belt load (i.e. high load limitation) or a digressive load limitation, similar to the previously discussed digressive bending element 165. Upon the failure of the torsion pipe 390, load limitation is taken over by the torsion bar 332, which can provide a second load limitation characteristic. The second load limitation characteristic of the torsion bar can be low constant load limitation, digressive load limitation, have a stepped down load limitation, or otherwise be tuned as is known and will be readily appreciated by those skilled in the art.

The features of the subject matter of this case as set forth in the herein above description, the patent claims, the summary, and the drawings, can be important individually or in desired combinations with one another in order to realize the invention in its various forms.

The present invention is, of course, in no way restricted to the specific disclosure of the specification and drawings, but also encompasses any modifications within the scope of the appended claims. The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A seat belt retractor comprising:
a spindle for winding a seat belt thereonto and unwinding a wound seat belt therefrom;
a frame rotatably supporting the spindle;
a torsion bar having opposing first and second ends, the first end connected to the spindle for fixed rotation therewith;
a tread head connected to the second end of the torsion bar for fixed rotation therewith;
a locking mechanism operably coupled to the tread head to selectively fix rotation of the tread head relative to the frame; and
a pretensioner having an actuating element and a drive wheel, the drive wheel directly connected to the tread head for fixed rotation therewith, the pretensioner operable from an inactive state to an active state, the actuating element disengaged from the drive wheel in the inactive state to permit rotation of the drive wheel and tread head, the actuating element engaged with the drive wheel in the active state to transmit force to the drive wheel.

2. The seat belt retractor of claim 1, wherein the drive wheel includes an opening defining an inner engagement surface, and wherein the tread head defines an outer engagement surface rotatably connected to the inner engagement surface of the drive wheel.

3. The seat belt retractor of claim 2, wherein the inner engagement surface defines a drive wheel spline, and wherein the outer engagement surface defines a tread head spline meshed with the drive wheel spline.

4. The seat belt retractor of claim 2, wherein the opening has a non-circular shape, and wherein a body of the tread head includes a non-circular shape matching the shape of the opening.

5. The seat belt retractor of claim 1, wherein the drive wheel and tread head are unitarily formed as a single piece.

6. The seat belt retractor of claim 1, wherein the drive wheel is press-fit on the tread head.

7. The seat belt retractor of claim 1, wherein the locking mechanism includes a lock dog pivotally connected to the tread head, the lock dog responsive to rotation of the tread head to rotate radially outwardly.

8. The seat belt retractor of claim 7, further comprising a pretensioner cover connected to the frame, and wherein the pretensioner cover defines a toothed gearing system having a teeth shaped to cooperate with the lock dog to permit winding of the seat belt and prevent unwind of the seat belt.

9. The seat belt retractor of claim 8, wherein operation of the pretensioner in the active state drives the tread head such that the lock dog rotates radially outwardly, the locking mechanism and its lock dog over-ratcheting the toothed gearing system.

10. The seat belt retractor of claim 1, wherein the pretensioner is a pyrotechnic roto-pretensioner and the actuating element is a plurality of pretensioner balls sized to engage a pinion of the drive wheel.

11. The seat belt retractor of claim 1, wherein the tread head defines a profiled end surface that cooperates with the locking mechanism, and wherein the drive wheel is located between the profiled end surface and the frame.

12. A seat belt retractor comprising:
a spindle for winding a seat belt thereonto and unwinding a wound seat belt therefrom;
a frame rotatably supporting the spindle
a torsion bar having opposing first and second ends, the first end connected to the spindle;
a tread head connected to the second end of the torsion bar;
a locking mechanism operably coupled to the tread head to selectively fix rotation of the tread head relative to the frame;
a pretensioner having an actuating element, a drive wheel, and a clutch mechanism, the drive wheel rotatably coupled to the tread head via the clutch mechanism for selective rotation therewith, the clutch mechanism including a coupling element moveably connected to the drive wheel, the pretensioner operable from an inactive state to an active state;
the inactive state characterized by the actuating element being engaged with the drive wheel, and the clutch mechanism decoupling the drive wheel from the tread head, to permit rotation of the tread head; and
the active state characterized by the clutch mechanism coupling the drive wheel to the tread head to transmit force to the torsion bar and spindle.

13. The seat belt retractor of claim 12, wherein the coupling element comprises coupling pawls rotatably connected to the drive wheel.

14. The seat belt retractor of claim 12, wherein the pretensioner includes a pyrotechnic charge which drives the coupling element of the clutch mechanism.

15. The seat belt retractor of claim 12, wherein the coupling element is activated by an electronic signal that activates the pretensioner.

16. The seat belt retractor of claim 12, further comprising a pretensioner housing connected to the frame, the pretensioner housing defining an engagement surface, the locking mechanism having a lock dog positioned to operatively engage the engagement surface.

17. The seat belt retractor of claim 16, wherein the pretensioner housing defines an opening sized to receive the tread head, the opening defining the engagement surface, and wherein the lock dog is pivotally connected to the tread head and rotates radially outwardly to engage the engagement surface.

18. A seat belt retractor comprising:
a spindle for winding a seat belt thereonto and unwinding a wound seat belt therefrom;
a frame rotatably supporting the spindle;
a torsion bar having opposing first and second ends, the first end connected to the spindle;
a tread head connected to the second end of the torsion bar;
a locking mechanism operably coupled to the tread head to selectively fix rotation of the tread head relative to the frame; and
a pretensioner having an actuating element and a drive wheel, the drive wheel connected to the tread head for rotation therewith, the pretensioner operable from an inactive state to an active state; and
a torsion pipe having a first end and a second end, the first end coupled to the tread head for fixed rotation therewith, the second end coupled to the spindle proximate the second end of the torsion bar for fixed rotation therewith.

19. The seat belt retractor of claim 18, wherein the retractor limits loading of the seat belt by deforming the torsion pipe and the torsion bar.

20. The seat belt retractor of claim 18, wherein the torsion pipe provides an initial high load limitation.

21. The seat belt retractor of claim 19, wherein the torsion pipe is designed to fail under a predetermined failure load, and wherein the torsion bar is activated upon failure of the torsion bar.

22. The seat belt retractor of claim 18, further comprising a pretensioner housing connected to the frame, the pretensioner housing defining an engagement surface, the locking mechanism having a lock dog positioned to operatively engage the engagement surface.

23. The seat belt retractor of claim 18, wherein the pretensioner further includes a clutch mechanism, the drive wheel rotatably coupled to the tread head via the clutch mechanism for selective rotation therewith, the clutch mechanism including a coupling element moveably connected to the drive wheel, the pretensioner operable from an inactive state to an active state, and wherein the inactive state is characterized by the actuating element being engaged with the drive wheel, and the clutch mechanism decoupling the drive wheel from the tread head, to permit rotation of the tread head, and wherein the active state is characterized by the clutch mechanism coupling the drive wheel to the tread head to transmit force to the torsion bar and spindle.
